(19) United States
(12) Patent Application Publication
(10) Pub. No.: US 2024/0381446 A1
(43) Pub. Date: Nov. 14, 2024

(54) DEVICE IDENTIFICATION METHOD AND APPARATUS

(71) Applicant: FUJITSU LIMITED, Kawasaki-shi Kanagawa (JP)

(72) Inventors: Meiyi JIA, Beijing (CN); Lei ZHANG, Beijing (CN); Su YI, Beijing (CN)

(73) Assignee: FUJITSU LIMITED, Kawasaki-shi Kanagawa (JP)

(21) Appl. No.: 18/782,265

(22) Filed: Jul. 24, 2024

Related U.S. Application Data
(63) Continuation of application No. PCT/CN2022/074842, filed on Jan. 28, 2022.

(51) Int. Cl. H04W 74/0836; H04L 5/00; H04W 74/08; H04W 76/20

(52) U.S. Cl. CPC H04W 74/0836; H04L 5/0051; H04W 74/0891; H04W 76/20

(57) ABSTRACT

A device identification apparatus, applicable to a first network device, the device identification apparatus includes: a receiver configured to receive first information transmitted by a first device, wherein, the first information is used to indicate that the first device is a Network-Controlled repeater or is used to determine that the first device connects to a network as a Network-Controlled repeater, or, the first information is repeater-specific first information.

### CROSS-REFERENCE TO RELATED APPLICATION

This application is a continuation application of International Application PCT/CN2022/074842 filed on Jan. 28, 2022, and designated the U.S., the entire contents of which are incorporated herein by reference.

### FIELD

This disclosure relates to the field of communication technologies.

### BACKGROUND

Compared with traditional 3G (third generation mobile communication technology) and 4G (fourth generation mobile communication technology) systems, a 5G (fifth generation mobile communication technology) system is able to provide larger bandwidths and higher data rates, and is able to support more types of terminals and vertical services. For this reason, a deployment frequency of a 5G system is obviously higher than those of 3G and 4G systems. For example, a 5G system may be deployed in a millimeter waveband.

However, the higher a carrier frequency, the more severe a fading experienced by signals during transmission. Therefore, in actual deployment of a 5G system, especially in the millimeter waveband, how to better enhance cell coverage has become an urgent problem to be solved.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

In order to better solve the coverage problem of cellular mobile communication systems in practical deployment, use of a radio frequency (RF) repeater to amplify and forward signals between a terminal equipment and a network device is commonly used means of deployment. RF repeaters are widely used in actual deployment of 3G and 4G systems. Generally speaking, an RF repeater is a device that amplifies and forwards signals between a network device and a terminal equipment in the RF domain.

One of feasible solutions to address the coverage problem encountered in the deployment of 5G systems is to use RF repeaters for coverage enhancement. However, traditional repeaters do not have the ability to communicate with network devices and are unable to obtain information of uplink and downlink configurations from the network devices. Therefore, deploying such repeaters in 5G systems, although it is helpful to enhancement of signal strengths, is not flexible enough to cope with complex environmental changes, and thus unable to achieve the same effects as deploying the same RF repeaters in 3G and 4G systems.

A smart repeater is enhancement of a traditional RF repeater, and has the ability to receive and process side control information from a network. The side control information allows the smart repeater to perform its amplification and forwarding operations in a more efficient manner. Hence, unnecessary noise amplification may be reduced, transmission and reception having better spatial directionality may be provided, and network integration may be simplified.

However, it was found by the inventors that for scenarios where smart repeaters are deployed, in a procedure where a smart repeater assesses to a network, there is currently no method for identifying a smart repeater, i.e. there is currently no method for determining a smart repeater.

In order to solve at least one of the above problems, embodiments of this disclosure provide a device identification method and apparatus.

According to one aspect of the embodiments of this disclosure, there is provided a device identification method, applicable to a first network device, the method including:
receiving first information transmitted by a first device, wherein,
the first information is used to indicate that the first device is a repeater or is used to determine that the first device connects to a network as a repeater; or, the first information is repeater-specific first information; or, the first information is transmitted on a first resource, the first resource being a repeater-specific first resource.

According to another aspect of the embodiments of this disclosure, there is provided a device identification method, applicable to a first device, the method including:
transmitting first information by the first device to a first network device, the first information being used to indicate that the first device is a repeater or being used to determine that the first device connects to a network as a repeater, or, the first information being repeater-specific first information, or, the first information being transmitted on a first resource, the first resource being a repeater-specific first resource.

According to a further aspect of the embodiments of this disclosure, there is provided a device identification apparatus, applicable to a first network device, characterized in that the apparatus includes:
a receiving unit configured to receive first information transmitted by a first device, wherein,
the first information is used to indicate that the first device is a repeater or is used to determine that the first device connects to a network as a repeater; or, the first information is repeater-specific first information; or, the first information is transmitted on a first resource, the first resource being a repeater-specific first resource.

According to still another aspect of the embodiments of this disclosure, there is provided a device identification apparatus, applicable to a first device, characterized in that the apparatus includes:
a transmitting unit configured to transmit first information to a first network device, the first information being used to indicate that the first device is a repeater or being used to determine that the first device connects to a network as a repeater, or, the first information being repeater-specific first information, or, the first information being transmitted on a first resource, the first resource being a repeater-specific first resource.

An advantage of the embodiments of this disclosure exists in that the network device is enabled according to the first information and/or the first resource to determine that the first device is a repeater or determine that the first device connects to a network as a repeater, and furthermore, the network device may be enabled to identify and distinguish whether the first device is a repeater or a normal terminal equipment, so that the network device separately processes connecting, message transmission, identification and authentication of the repeater, thereby achieving flexible deployment of repeaters and lowering network deployment costs.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is schematic diagram of an application scenario of an embodiment of this disclosure;

FIG. 2 is a schematic diagram of receiving and transmitting signals by a repeater in an embodiment of this disclosure;

FIG. 3 is another schematic diagram of receiving and transmitting signals by the repeater in the embodiment of this disclosure;

FIG. 4 is a schematic diagram of a device identification method of an embodiment of this disclosure;

FIG. 5 is a schematic diagram of a device identification method of an embodiment of this disclosure;

FIG. 6 is a schematic diagram of a device identification apparatus of an embodiment of this disclosure;

FIG. 7 is a schematic diagram of a device identification apparatus of an embodiment of this disclosure;

FIG. 8 is a schematic diagram of a network device of an embodiment of this disclosure;

FIG. 9 is a schematic diagram of a first device of an embodiment of this disclosure; and

FIG. 10 is a schematic diagram of a terminal equipment of an embodiment of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the spirit and terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term. Without causing confusion, “a cell” and “a base station” are interchangeable.

In the embodiments of this disclosure, the term “user equipment (UE)” or “a terminal equipment (TE) or a terminal device” refers to, for example, an equipment accessing to a communication network and receiving network services via a network device. The terminal equipment may be fixed or mobile, and may also be referred to as a mobile station (MS), a terminal, a subscriber station (SS), an access terminal (AT), an IAB-MT, or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the user equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or a core network device, and may include one or more network devices described above. The term “user side” or “terminal side” or “terminal equipment side” refers to a side of a user or a terminal, which may be a UE, and may include one or more terminal equipment described above. In this text, “a device” may refer to a network device, or may refer to a terminal equipment, except specified otherwise.

Scenarios of the embodiments of this disclosure shall be described below by way of examples; however, this disclosure is not limited thereto.

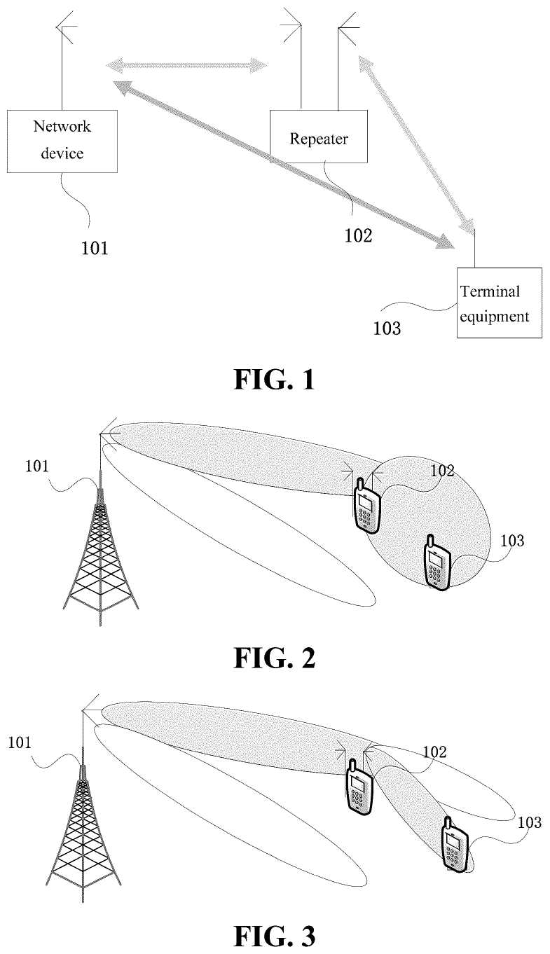

FIG. 1 is schematic diagram of an application scenario of an embodiment of this disclosure. As shown in FIG. 1, for the sake of description, the description shall be given by taking a network device (such as a 5G gNB or gNB-CU) 101, a repeater 102 and a terminal equipment (UE) 103 as examples; however, this disclosure is not limited thereto. As shown in FIG. 1, the terminal equipment 103 may establish connection with the network device 101 and communicate therewith. In order improve communication quality, signals between the terminal equipment 103 and the network device 101 may be processed (such as being amplified) by the repeater 102.

As shown in FIG. 1, radiated or conducted RF carriers are received, processed and transmitted in a downlink direction (from a network device to a terminal equipment) and an uplink direction (from the terminal equipment to the network device). The processing includes power amplification, beamforming, and reshaping a propagation environment, etc. In an operating frequency band where only downlink or uplink is designated, only the designated uplink or downlink is repeated.

FIGS. 2 and 3 are schematic diagrams of receiving and transmitting signals by the repeater. As shown in FIG. 2, the repeater includes an omnidirectional or fixed-direction (non-adaptive along with the time) Tx/Rx repeater or a repeater with an adaptive ability along with the time. As shown in FIG. 3, beams for transferring RF signals are controlled by the network device (such as an RAN node).

In the embodiments of this disclosure, existing traffics or traffics that may be implemented in the future may be performed between the network device and the terminal equipment. For example, such traffics may include but not limited to enhanced mobile broadband (eMBB), massive machine type communication (mMTC), ultra-reliable and low-latency communication (URLLC), and Vehicle to Everything (V2X), etc.

Description in FIG. 1 is given by taking that the repeater is able to forward signals between the network device and the terminal equipment as an example; however, this disclosure is not limited thereto. For example, a repeater may act as a second device and forward signals between a first device and a third device, and is able to communicate directly with the first device and/or the third device. The first device, second device and third device may be any devices in the above-described network. In the following embodiments, description shall be given by taking that the first device is a network device and the third device is a terminal equipment as an example.

In the embodiments of this disclosure, the beam may also be expressed as a lobe, a reference signal (RS), a transmission configuration indication (TCI), and a spatial domain filter, etc., or, it may also be expressed as a beam index, a lobe index, a reference signal index, a transmission configuration indication index, and a spatial filter index, etc. The reference signal is, for example, a channel state information reference signal (CSI-RS), a sounding reference signal (SRS), an RS used by a repeater, and an RS transmitted by a repeater, etc. The TCI may also be expressed as a TCI state.

In the embodiments of this disclosure, the repeater may also be expressed as a network controlled repeater (NCR), or a reconfigurable intelligent surface (RIS), or a repeater station, or a relay, or a radio frequency repeater, or a radio frequency relay; or, it may also be expressed as a repeater station node, a relay node; or, it may also be expressed as an intelligent repeater, an intelligent relay, an intelligent repeater node, and an intelligent relay node, etc. The repeater may be a node, or a device, or an entity, etc., and this disclosure is not limited thereto.

In the embodiments of this disclosure, the network device may be a device of a serving cell of a terminal equipment, or may also be a device of a cell where the repeater is located, or a device of a serving cell of the repeater, or a parent node of the repeater. Names of the repeater are not limited in this disclosure, and any device capable of achieving the above functions is included in the scope of the repeater of this disclosure.

For a scenario where a smart repeater is deployed, when the smart repeater communicates with a network device, the network devices need to identify the smart repeater so as to perform subsequent communication with the smart repeater. In addition, if the smart repeater directly adopts a method for identifying a normal terminal equipment in existing communication standards, the network device is still unable to distinguish between a smart repeater and a normal terminal equipment. Therefore, there is a need to introduce a specific identification method for a smart repeater.

Addressed to the above problems, various implementations of the embodiments this disclosure shall be described below with reference to the accompanying drawings. These implementations are illustrative only, and are not intended to limit this disclosure.

### Embodiments of a First Aspect

The embodiments of this disclosure provide a device identification method, which shall be described from a side of a first network device.

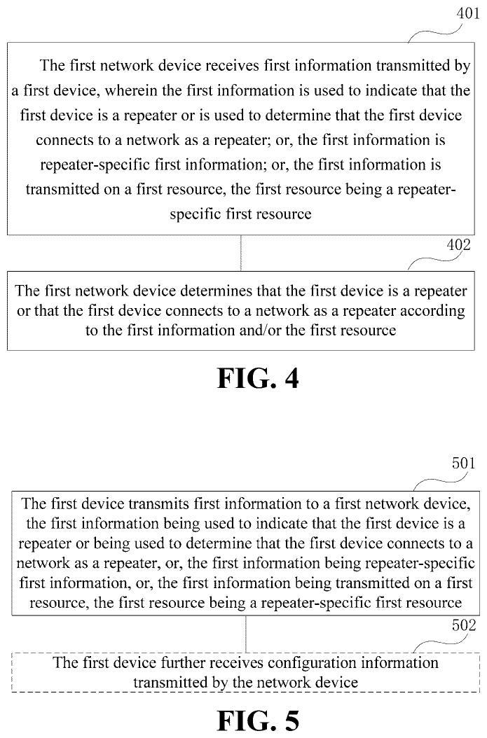

FIG. 4 is a schematic diagram of a device identification method of the embodiment of this disclosure. As shown in FIG. 4, the method includes:
401: the first network device receives first information transmitted by a first device,
wherein the first information is used to indicate that the first device is a repeater or is used to determine that the first device connects to a network as a repeater; or, the first information is repeater-specific first information; or, the first information is transmitted on a first resource, the first resource being a repeater-specific first resource.

Hence, the first network device is enabled according to the first information and/or the first resource to determine that the first device is a repeater or determine that the first device connects to a network as a repeater, and furthermore, the first network device may be enabled to identify and distinguish whether the first device is a repeater or a normal terminal equipment, so that the network device separately processes connecting, message transmission, identification and authentication of the repeater, thereby achieving flexible deployment of repeaters and lowering network deployment costs.

It should be noted that FIG. 4 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 4.

In some embodiments, the first information and/or the first resource may be first information in the random access procedure and/or a first resource used in the random access procedure, or the first information may also be first information after the random access procedure is completed. For ease of understanding, the random access procedure shall be exemplarily described below.

In some embodiments, in a scenario where a smart repeater is deployed, the smart repeater needs to connect to the network through a random access procedure, such as a 4-step random access procedure or a 2-step random access procedure. The random access procedure includes a contention-based random access procedure and/or a non-contention-based random access procedure. And the random access procedure further includes an initial random access procedure and/or a random access in a radio resource control (RRC) reestablishment process and/or a random access in handover procedure, etc., and this disclosure is not limited thereto.

The 4-step random access procedure and the 2-step random access procedure performed between the repeater and the first network device shall be exemplified below.

For example, taking a contention-based random access procedure as an example, the 4-step random access procedure includes: step 1: transmitting message 1 (MSG1) on a random access resource by the repeater to the first network device, such as transmitting a random access preamble; step 2: transmitting message 2 (MSG2) by the first network device to the repeater, such as transmitting a random access response (RAR), which may indicate a Temporary Cell Access Radio Network Temporary Identifier (TC-RNTI) and allocate resources for subsequent message 3 (MSG3); step 3: transmitting message 3 (MSG3) by the repeater to the first network device, such as adjusting uplink timing, etc.; and step 4: transmitting message 4 (MSG4) by the first network device to the repeater, indicating successful contention-based random access, and upgrading the TC-RNTI to a C-RNTI, etc. After completing the 4-step random access procedure, the repeater may further transmit the first message after the random access procedure is completed, which may be referred to as, for example, message 5 (MSG5), and then the repeater may perform subsequent signaling transmission with the first network device. In some embodiments, reference may be made to existing techniques for specific contents of MSG1-MISG5, which shall not be enumerated herein any further.

For example, taking the contention-based random access procedure as an example, the 2-step random access procedure includes: step A, transmitting message A (MSGA) by the repeater on a random access resource to the first network device, such as transmitting a random access preamble and/or uplink data; step B: transmitting message B (MSGB) by the first network device to the repeater, such as transmitting a random access response (RAR), which may indicate successful contention-based random access. After completing the 2-step random access procedure, the repeater may perform subsequent signaling transmission with the first network device. In some embodiments, reference may be made to existing techniques for specific contents of MSGA-MSGB, which shall not be enumerated herein any further.

How to identify that the first device is a repeater or how to determine that the first device connects to the network as a repeater by the first network device shall be described below.

In some embodiments, the first network device determines that the first device is a repeater or connects to the network as a repeater according to the first information and/or the first resource. For example, the first information is used to indicate that the first device is a repeater or is used to determine that the first device connects to the network as a repeater; or, the first information is repeater-specific first information; or, the first information may be transmitted on the first resource, the first resource being a repeater-specific first resource.

For example, the repeater-specific first resource includes: a random access resource carrying a random access preamble (corresponding to the first information) of MSG1/MSGA in a random access procedure, or a physical uplink shared resource (PUSCH) carrying MSGA in a random access procedure; and the first information includes at least one of the following information: a random access preamble of MSG1/MSGA in a random access procedure; relevant information on a payload carried by MSG3 in the random access procedure or MSGA in the random access procedure; first indication information in a first message after the random access procedure is completed; or second indication information or third indication information in a capability-related message.

For example, in some embodiments, based on the first resource used by the first device in the random access procedure, the first network device determines whether the first device is a repeater or connects to the network as a repeater. Or, based on the random access preamble in MSG1/MSGA transmitted by the first device in the random access procedure, the first network device determines whether the first device is a repeater or connects to the network as a repeater. Or, based on the relevant information on the payload carried by the MSG3/MSGA transmitted by the first device in the random access procedure, the first network device determines whether the first device is a repeater or connects to the network as a repeater. Or, based on the first indication information in the first message of the first device after the random access procedure is completed, the first network device determines whether the first device is a repeater or connects to the network as a repeater. Or, based on the second indication information or third indication information in the capability-related message of the first device, the first network device determines whether the first device is a repeater or connects to the network as a repeater.

Respective explanations are given below.
(I) The first network device determines whether the first device is a repeater or connects to the network as a repeater based on the first resource.

In some embodiments, the first resource is repeater-specific, for example, the repeater-specific random access resource is used to carry the random access preamble of MSG1/MSGA transmitted by the repeater in the random access procedure, and the repeater-specific PUSCH is used to carry the MSGA transmitted by the repeater in the random access procedure.

In some embodiments, the first network device configures that a repeater-specific (newly added) PUSCH resource of the MSGA is transmitted in a random access procedure; or, the first network device designates a part of (existing) PUSCH resources in MsgA transmitted by a normal terminal in a random access procedure for the repeater.

In some embodiments, the information configured or designated by the first network device may be carried by broadcast information, such as using the following below (newly added) fields (domains) “msgA-PUSCH-ResourceGroupA-NCR” and/or “msgA-PUSCH-ResourceGroupB-NCR” and/or “frequencyStartMsgA-PUSCH msgA-PUSCH-NCR” and/or “Time DomainAllocation-NCR” in a PUSCH allocation IE “MsgA-PUSCH-Config” in MsgA transmitted in a SIB1 message. A definition of the above (newly added) fields (domains) are identical or similar to parameters of a normal terminal in IE “MsgA-PUSCH-Config”, and reference may be made to existing techniques for specific contents thereof, which shall not be enumerated herein any further.

In some embodiments, the information configured or designated by the first network device may be carried by broadcast information, such as by using the following (newly added) IE “MsgA-PUSCH-Config-NCR” in the SIB1 message, which at least includes fields (domains) “msgA-PUSCH-ResourceGroupA” and/or “msgA-PUSCH-Resource GroupB” and/or “frequencyStartMsgA-PUSCH msgA-PUSCH” and/or “TimeDomainAllocation”. For definitions (descriptions) and values of the above (newly added) fields (domains), parameters of a normal terminal in the IE “MsgA-PUSCH-Config” may be reused, and reference may be made to existing techniques for specific contents thereof, which shall not be enumerated herein any further.

In some embodiments, the first network device configures repeater-specific random access resources and transmits configuration information to the first device, the configuration information including repeater-specific PRACH configuration information. The first resource is determined according to the repeater-specific PRACH configuration information, or the repeater-specific first resource is selected from random access resources configured by the repeater-specific PRACH configuration information.

In some embodiments, the first network device configures a (newly added) random access resource different from that of the normal terminal equipment for the repeater, and transmits the PRACH configuration information corresponding to the (newly added) random access resource to the first device; or, the first network device divides a specific subset for the repeater in (existing) random access resources of random access preambles of the normal terminal equipment, and transmits the PARCH configuration information containing specific subset indication information to the first device.

In some embodiments, the above PRACH configuration information may be carried by broadcast information, such as a master system information block (MIB) and/or a system information block (SIB), wherein the system information block includes SIB1 and other SIBs, such as SIB2 and SIB3. Reference may be made to existing techniques for specific contents of SIB1 and other SIBs, which are not limited in this disclosure.

For example, the first network device configures a (newly added) random access resource different from that of a normal terminal equipment for the repeater, and transmits the PRACH configuration information corresponding to the (newly added) random access resource to the first device. The PRACH configuration information corresponding to the (newly added) random access resource may include at least one of the following information:
the number of PRACH transmission occasions (PRACH occasion) frequency-division multiplexed in one time instance, wherein one time instance may be one or more slots, or one or more subframes, or one or more system frames, etc., which are not limited in this disclosure; in addition, the PRACH occasion is a position of the PRACH resource in a PRACH period, and a time-domain position of the PRACH occasion may be indicated by a specific field (domain) in the SIB1 message, such as a field “RACH-ConfigGeneric”; reference may be made to existing techniques for how to calculate the PRACH occasion, which is not limited in this disclosure;
an offset of a lowest PRACH transmission occasion in a frequency domain relative to a physical resource block 0 (PRBO);
an index of PRACH configuration, wherein the PRACH configuration is determined jointly by one or more of following parameters: a radio frame where the PRACH resource is located, a PRACH period, a subframe number where the PRACH resource is located, a starting symbol of the PRACH resource in an RACH slot, the number of time-domain PRACH occasions in an RACH slot, a time-domain symbol length of a frequency-domain PRACH occasion, and the number of PRACH slots in a subframe, and reference may be made to existing techniques for a specific calculation method, which is not limited in this disclosure; for example, the index of the PRACH configuration corresponds to a row in a repeater-specific PRACH configuration table;
a subcarrier spacing (SCS) of a PRACH, such as 15 kHZ, 30 kHZ, and 60 kHZ, etc.; and
the number of synchronization signal and PBCH blocks (SSBs) per RACH occasion.

In some embodiments, one or more of the above information may be indicated by newly adding a field (domain) in the SIB1 message; for example, for the 4-step random access procedure, it may be indicated by a field “RACH_ConfigCommon-NCR”, and for the 2-step random access procedure, it may be indicated by a field “RACH_ConfigCommonTwoStepRA-NCR”. Names of the above or following fields are illustrative only, and the embodiments of this disclosure is not limited thereto.

In some embodiments, the first network device configures the repeater-specific (newly added) random access resources for the repeater. In a case where the first device is a repeater, after receiving NCR-specific fields related to random access resources in the SIB1 message, the first device may obtain the above repeater-specific random access parameters. The first device may select/use the repeater-specific random access resources, such as obtaining the repeater-specific (newly added) random access resources through calculation by using the above random access parameters when the random access procedure is initialized; or, the first device may select a downlink reference signal (such as an SSB and/or a CSI-IRS) after obtaining the repeater-specific random access parameters, the downlink reference signal being configured with the repeater-specific random access resources; or, the first device determines the repeater-specific random access resources from multiple random access resources associated with the downlink reference signal according to the selected downlink reference signal, and then transmits MSG1/MSGA (including random access preambles) on the repeater-specific (newly added) random access resources. After receiving MSG1/MSGA on the repeater-specific (newly added) random access resources, the first network device may identify that the first device is a repeater. On the contrary, in a case where the first device is not a repeater but a normal terminal equipment, the first device ignores the fields related to the repeater-specific random access resources in the SIB1 message, and then uses existing random access resources to transmit the random access preambles.

Therefore, the first resource may implicitly indicate that the first device is a repeater or determine that the first device connects to the network as a repeater. On a repeater-specific first resource, i.e. the repeater-specific random access resource, the first network device receives MSG1/MSGA transmitted by the first device, and identifies that the first device is a repeater or determines that the first device connects to the network as a repeater. Thus, a process of identifying a repeater is achieved.

In some embodiments, the first network device divides the specific subset for the repeater in the (existing) random access resources of the random access preambles of the normal terminal equipment, and transmits the PARCH configuration information containing indication information of the above specific subset to the first device, the above specific subset including at least one of the following information:
a scaling factor of a PRACH configuration period, wherein the scaling factor may be a scaling factor of a period defined in extended basic configuration, its value range is “1, 2, 4, 8, 16, 32, 64”, etc., and it may indicate one or more values in the value range via a field “prach-ConfigurationPeriodScaling-NCR” in higher-layer signaling;
a frame offset of a PARCH transmission occasion, wherein its value range may be “0-63”, and a part of values in the value range may be indicated via a field “rach-ConfigurationFrameOffset-NCR” in higher-layer signaling; or
a subframe offset or slot offset of a PARCH transmission occasion, wherein its value range is “0-39”, and a part of values in the value range may be indicated via a field “prach-ConfigurationSOffset-NCR” in higher-layer signaling.

In some embodiments, one or more of the above information (prach-ConfigurationPeriodScaling-NCR, rach-ConfigurationFrameOffset-NCR, prach-ConfigurationSOffset-NCR) may be indicated by an existing field (domain) in the SIB1 message. For example, for the 4-step random access procedure, it may be indicated by a field “RACH-ConfigGeneric”, and for the 2-step random access procedure, it may be indicated by a field “RACH-ConfigGenericTwoStepRA”. Names of the above or following fields are illustrative only, and the embodiments of this disclosure is not limited thereto.

In some embodiments, the first network device divides a subset of (existing) random access resources of the normal terminal equipment and takes it as the repeater-specific random access resources. In the case where the first device is a repeater, after receiving the NCR-specific fields related to random access resources in the SIB1 message, the first device may obtain random access parameters in the repeater-specific subset. The first device may select/use the repeater-specific random access resources, such as obtaining the repeater-specific (existing) random access resources through calculation by using the above random access parameters when the random access procedure is initialized; or, the first device may select a downlink reference signal (such as an SSB and/or a CSI-IRS) after obtaining the repeater-specific random access parameters, the downlink reference signal being configured with the repeater-specific random access resources; or, the first device determines the repeater-specific random access resources from multiple random access resources associated with the downlink reference signal according to the selected downlink reference signal, and then transmits MSG1/MSGA (including random access preambles) on the repeater-specific (existing) random access resources. After receiving MSG1/MSGA on the repeater-specific (existing) random access resources, the first network device may identify that the first device is a repeater. On the contrary, in a case where the first device is not a repeater but a normal terminal equipment, the first device ignores the fields related to the repeater-specific random access resources in the SIB1 message, and then uses existing normal terminal equipment specific random access resources to transmit the random access preambles.

Therefore, the first resource may implicitly indicate that the first device is a repeater or determine that the first device connects to the network as a repeater. On a repeater-specific first resource, i.e. the repeater-specific random access resource, the first network device receives MSG1/MSGA transmitted by the repeater, and identifies that the first device is a repeater or determines that the first device connects to the network as a repeater. Thus, a process of identifying a repeater is achieved.

It should be noted that the random access preambles carried by the first resource may be determined in an existing method, or may be determined in a method in “(II)”, and the embodiments of this disclosure is not limited thereto.
(II) The first network device determines whether the first device is a repeater or connects to the network as a repeater based on the random access preamble in MSG1/MSGA transmitted by the first device in the random access procedure.

In some embodiments, the random access preamble is a repeater-specific random access preamble.

In some embodiments, the first network device configures the repeater-specific random access preamble and transmits the configuration information to the first device, the configuration information including repeater-specific random access preamble configuration information. The random access preamble taken as the first information is determined according to the repeater-specific random access preamble configuration information, or in other words, the repeater-specific random access preamble is selected from the random access preamble configured by the repeater-specific random access preamble configuration information.

In some embodiments, for example, the first network device configures a (newly added) random access preamble for the repeater that is different from that of the normal terminal equipment, and transmits the random access preamble configuration information corresponding to the (newly added) random access preamble to the first device, or the first network device divides a specific subset of the random access preambles in (existing) random access preambles of the normal terminal equipment for the repeater, and transmits the random access preamble configuration information containing indication information of the specific subset to the first device.

In some embodiments, the above random access preamble configuration information may be carried by broadcast information, such as a master system information block (MIB) and/or a system information block (SIB), wherein the system information block includes SIB1 and other SIBs, such as SIB2 and SIB3. Reference may be made to existing techniques for specific contents of SIB1 and other SIBs, which are not limited in this disclosure.

For example, the first network device configures a (newly added) random access preamble that is different from that of the normal terminal equipment for the repeater, and transmits the random access preamble configuration information corresponding to the (newly added) random access preamble to the first device, the random access preamble configuration information corresponding to the (newly added) random access preamble including at least one of the following
a PRACH root sequence index, wherein the PRACH root sequence may be a ZC sequence, etc., and reference may be made to existing techniques for a meaning thereof, which shall not be enumerated herein any further;
the number of preambles used for contention-based random access of the repeater;
the number of contention-based preambles per SSB in group A, wherein group A is the number of preambles divided in the contention-based random access procedure, and is applicable to terminal equipment located in the middle of the cell or with good communication quality; and reference may be made to existing standards for a definition of group A, which is not limited in this disclosure;
the number of contention-based preambles per SSB; or
a total number of preambles used for contention-based 4-step random access or 2-step random access in an RACH resource.

In some embodiments, one or more of the above information may be indicated by adding a field (domain) in the SIB1 message; for example, for the 4-step random access procedure, it may be indicated by a field “RACH_ConfigCommon-NCR”, and for the 2-step random access procedure, it may be indicated by a field “RACH_ConfigCommonTwoStepRA-NCR”.

In some embodiments, the first network device configures (newly added) random access preambles different from that of the normal terminal equipment for the repeater. In the case where the first device is a repeater, after receiving the NCR-specific field related to the random access preamble in the SIB1 message, the first device may select/use the repeater-specific random access preambles, such as obtaining the repeater-specific (newly added) random access preambles through calculation by using the above random access preamble parameters when the random access procedure is initialized; or, the first device may select a downlink reference signal (such as an SSB and/or a CSI-IRS) after obtaining the repeater-specific random access preamble parameters, the downlink reference signal being configured with the repeater-specific random access preambles; or, the first device determines the repeater-specific random access preambles from multiple random access preambles associated with the downlink reference signal according to the selected downlink reference signal, and then transmits the repeater-specific (newly added) random access preambles. After receiving MSG1/MSGA on the random access resources, the first network device may identify that the first device is a repeater according to the repeater-specific random access preambles carried by MSG1/MSGA. On the contrary, in a case where the first device is not a repeater but a normal terminal equipment, the first device ignores the fields related to the repeater-specific random access preambles in the SIB1 message, and then transmits the existing random access preambles.

Therefore, the repeater-specific random access preambles may implicitly indicate that the first device is a repeater or determine that the first device connects to the network as a repeater. The first network device receives the repeater-specific (newly added) random access preambles, and identifies that the first device is a repeater or determines that the first device connects to the network as a repeater. Thus, a process of identifying a repeater is achieved.

For another example, the first network device divides a repeater-specific subset of random access preambles from the (existing) random access preambles of the normal terminal equipment, and transmits the random access preamble configuration information containing specific subset indication information to the first device. The specific subset indication information may also be referred to as existing random access preamble subset indication information.

For example, the (existing) random access preambles are shared with the repeater or the (existing) random access preambles are dedicated-used for the repeater.

In some embodiments, the first network device divides a subset of (existing) random access preambles of the normal terminal equipment for the repeater and takes it as repeater-specific random access preambles. In a case where the first device is a repeater, after receiving the NCR-specific fields related to the random access preambles in the SIB1 message, the first device may obtain random access parameters in the repeater-specific subset. The first device may select/use the repeater-specific random access resources, such as obtaining the repeater-specific (existing) random access preambles through calculation by using the above random access parameters when the random access procedure is initialized; or, the first device may select a downlink reference signal (such as an SSB and/or a CSI-IRS) after obtaining the repeater-specific random access parameters, the downlink reference signal being configured with the repeater-specific random access preambles; or, the first device determines the repeater-specific random access preambles from multiple random access preambles associated with the downlink reference signal according to the selected downlink reference signal, and then transmits the repeater-specific (existing) random access preambles. After receiving MSG1/MSGA on the random access resources, the first network device may identify that the first device is a repeater according to the repeater-specific random access preambles carried by MSG1/MSGA. On the contrary, in a case where the first device is not a repeater but a normal terminal equipment, the first device ignores the repeater-specific fields related to the random access preambles in the SIB1 message, and then transmits the existing normal terminal equipment-specific random access preambles.

Therefore, the repeater-specific random access preambles may implicitly indicate that the first device is a repeater or determine that the first device connects to the network as a repeater. The first network device receives the repeater-specific (existing) random access preambles, and identifies that the first device is a repeater or determines that the first device connects to the network as a repeater. Thus, a process of identifying a repeater is achieved.
(III) The first network device determines whether the first device is a repeater or connects to the network as a repeater based on the relevant information on the payload carried by the MSG3/MSGA transmitted by the first device in the random access procedure.

In some embodiments, the first network device determines whether the first device is a repeater or connects to the network as a repeater based on the relevant information on the payload carried by the MSG3/MSGA transmitted by the repeater. For example, the relevant information includes cause value information or user identifier (UE ID).

For example, the relevant information includes cause value information, the cause value information being a predetermined value indicating that the first device is a repeater or connects to the network as a repeater.

In some embodiments, the cause value information may include an establishment cause value or a resume cause value, wherein the establishment cause value is indicated by a higher layer of the first device to an RRC layer or is determined by the RRC layer itself (based on a capability of the device itself) of the first device. When MSG3 is an RRC request, the cause value information may be denoted by a field establishmentCause. The resume cause value is indicated by a higher layer of the first device to an access stratum (AS, at least including an RRC layer) or is determined by the AS itself of the first device. When MSG3 is RRC resume, the cause value information may be denoted by a field establishmentCause.

In some embodiments, multiple types of cause values may be predefined, and may at least include the predetermined value indicating that the first device is a repeater or that the first device connects to the network as a repeater. In a case where the first device is a repeater, the first device carries the cause value information in MSG3/MSGA, and the repeater-specific cause value information is the predetermined value. After receiving the MSG3/MSGA, the first network device decodes the cause value information, and identifies that the first device is a repeater or determines that the first device connects to the network as a repeater. On the contrary, in a case where the first device is not a repeater but a normal terminal equipment, the cause value carried by the MSG3/MSGA transmitted by the normal terminal equipment another value than the predetermined value, and reference may be made to existing techniques for details, which shall not be enumerated herein any further.

Therefore, the predetermined value in the relevant information may explicitly indicate that the first device is a repeater or determine that the first device connects to the network as a repeater. After receiving the cause value information carried by MSG3/MSGA transmitted by the first device, the first network device identifies that the first device is a repeater or determines that the first device connects to the network as a repeater; otherwise, the first network device identifies that the first device is a normal terminal equipment. Thus, a process of identifying a repeater is achieved.

For example, the relevant information includes a user identifier (UE ID), which is a predetermined value indicating that the first device is a repeater or connects to the network as a repeater.

In some embodiments, a core network (a second network device of) provides a repeater-specific device identifier in advance for the repeater, the repeater-specific device identifier being a predetermined identifier indicating that the first device is a repeater or connects to the network as a repeater. Furthermore, a higher layer of the repeater provides an RRC layer with the repeater-specific device identifier, and the user identifier (UE ID) is obtained according to the repeater-specific device ID configured by the second network device for the repeater. For example, the RRC layer uses a part of bit information (e.g. 39 bits) of the repeater-specific device identifier as the user identifier (UE ID), and the repeater carries the determined UE ID via MSG3/MSGA. For example, the repeater-specific device identifier (NCR-UE ID) may be determined based on a 5G-SAE temporary mobile subscriber identifier (5G-S-TMSI).

In some embodiments, in the case where the first device is a repeater, the first device carries a part of bit information (e.g. 39 bits) of the repeater-specific device identifier (NCR-UE ID) (predetermined identifier) carried by MSG3/MSGA as the UE ID. After receiving the UE ID, the first network device obtains the repeater-specific device identifier by decoding, and identifies that the first device is a repeater or determines that the first device connects to the network as a repeater. On the contrary, in the case where the first device is not a repeater but a normal terminal equipment, the MSG3/MSGA transmitted by the normal terminal equipment carries the UE ID of the normal repeater device.

Therefore, the user identifier in the relevant information may implicitly indicate that the first device is a repeater or determine that the first device connects to the network as a repeater. After receiving the user identifier carried by MSG3/MSGA transmitted by the first device, the first network device may identify that the first device is a repeater or determine that the first device connects to the network as a repeater; otherwise, the first network device identifies that the first device is a normal terminal equipment of the repeater. Thus, a process of identifying a repeater is achieved.
(IV) The first network device determines that the first device is a repeater or connects to the network as a repeater based on the first message (Msg5) after the random access procedure is completed.

In some embodiments, the first network device determines that the first device is a repeater or connects to the network as a repeater based on the first indication information in the first message (Msg5) after the random access procedure is completed. For example, the first message (Msg5) is an RRC establishment complete message or an RRC resume complete message, and the first indication information is used to indicate that the first device is a repeater or indicate that the first device connects to the network as a repeater.

Alternatively, the first message after the random access procedure is completed may be MSG5 in the 4-step random access procedure, or the first message after MsgB in the 2-step random access procedure, and this disclosure is not limited thereto.

For example, whether the first device is a repeater is indicated by newly adding a specific bit field (domain) in the RRC establishment complete message or RRC resume complete message, such as adding 1 bit of information, wherein “O” indicates that a current first device is a repeater or may connect to the network as a repeater, and “1” indicates that the current first device is a normal terminal equipment; or, multiple bit information may be added; or, when the newly-added field is present, it indicates that the current first device is a repeater or may connect to the network as a repeater, or indicates that the first device has a capability of a repeater, and this disclosure is not limited thereto.

In some embodiments, after the 4-step or the 2-step random access procedure is completed, the first device transmits the first message after the random access is completed to the first network device. The first network device determines whether the first message transmitted by the first device carries the first indication information, and/or determines a value of the first indication information, so as to determine whether the first device is a repeater or connects to the network as a repeater.

Therefore, the first indication information may explicitly indicate that the first device is a repeater or determine that the first device connects to the network as a repeater. After receiving the first message, the first network device may identify that the first device is a repeater or determine that the first device connects to the network as a repeater. Thus, a process of identifying a repeater is achieved.
(V) The first network device determines that the first device is a repeater or connects to the network as a repeater based on the second indication information or the third indication information in the capability-related message of the first device.

In some embodiments, the first network device determines that the first device is a repeater or connects to the network as a repeater based on the second indication information or the third indication information contained in the capability-related message of the first device. For example, the capability-related message includes: a UE capability information (UECapabilityInformation) message or a UE assistance information (UEAssistanceInformation) message; the second indication information is used to indicate that the first device is a repeater or is used to indicate that the first device connects to the network as a repeater or is used to indicate that the first device has a capability of a repeater; and the third indication information is information indicating a first capability in the UE capability information (UECapabilityInformation) message or the UE assistance information (UEAssistanceInformation) message, the first capability being a repeater-specific capability.

For example, that the second indication information is used to indicate that the first device is a repeater or is used to indicate that the first device connects to the network as a repeater or that the first device has a capability of a repeater includes: adding a specific bit field (domain) to the UE capability information (UECapabilityInformation) message or the UE assistance information (UEAssistanceInformation) message to indicate that the first device is (a type of) a repeater or indicate that the first device connects to the network as a repeater or indicate that the first device has a capability of a repeater. For example, 1 bit of information is added, wherein “0” indicates that a current first device is a repeater or connects to the network as a repeater, and “1” indicates that the current first device is a normal terminal equipment; or, multiple bit information may be added; or, when the newly-added field is present, it indicates that the current first device is a repeater or connects to the network as a repeater, or indicates that the first device has a capability of a repeater, and this disclosure is not limited thereto.

In some embodiments, when the first network device receives the UE capability information (UECapabilityInformation) message or the UE assistance information (UEAssistanceInformation) message transmitted by the first device, it determines whether the message carries the second indication information, and/or determines a value of the second indication information, so as to determine whether the first device is a repeater or connects to the network as a repeater.

Therefore, the second indication information may explicitly indicate that the first device is a repeater or determine that the first device connects to the network as a repeater. After receiving the second message, the first network device may identify that the first device is a repeater or determine that the first device connects to the network as a repeater. Thus, a process of identifying a repeater is achieved.

For example, that the third indication information is information indicating a first capability in the UE capability information (UECapabilityInformation) message or the UE assistance information (UEAssistanceInformation) message, the first capability being a repeater-specific capability, includes: indicating that the first device has the first capability by an existing or newly-added bit field (domain) in the UE capability information (UECapabilityInformation) message or the UE assistance information (UEAssistanceInformation) message. For example, a value type of the bit field includes multiple capabilities, which at least include a capability that is a repeater-specific capability. When the first network device receives the third indication information in the UE capability information (UECapability Information) message or the UE assistance information (UEAssistanceInformation) message transmitted by the first device, and a value of the third indication information is a type corresponding to the repeater-specific capability (first capability), it determines whether the first device is a repeater or connects to the network as a repeater.

Therefore, by indicating the repeater-specific first capability, the third indication information may implicitly indicate that the first device is a repeater or determine that the first device connects to the network as a repeater. After receiving the third indication information, the first network device may identify whether the first device has the repeater-specific first capability, and identify that the first device is a repeater or determine that the first device connects to the network as a repeater. Thus, a process of identifying a repeater is achieved.

### Embodiments of a Second Aspect

The embodiments of this disclosure provide a device identification method, which shall be described from a side of a first device, with parts repeated with those in the embodiments of the first aspect being not going to be described herein any further.

FIG. 5 is a schematic diagram of a device identification method of the embodiment of this disclosure. As shown in FIG. 5, the method includes:
501: the first device transmits first information to a first network device, the first information being used to indicate that the first device is a repeater or being used to determine that the first device connects to a network as a repeater, or, the first information being repeater-specific first information, or, the first information being transmitted on a first resource, the first resource being a repeater-specific first resource.

Hence, the first network device is enabled according to the first information and/or the first resource to determine that the first device is a smart repeater or determine that the first device connects to a network as a repeater, and furthermore, the first network device may be enabled to identify and distinguish whether the first device is a repeater or a normal terminal equipment, so that the network device separately processes connecting, message transmission, identification and authentication of the repeater, thereby achieving flexible deployment of repeaters and lowering network deployment costs.

In some embodiments, the first resource includes: a random access resource carrying a random access preamble of MSG1/MSGA in the random access procedure, or a physical uplink shared resource (PUSCH) carrying MSGA in the random access procedure.

In some embodiments, the first information includes at least one of the following information:
a random access preamble of MSG1/MSGA in a random access procedure;
relevant information on a payload carried by MSG3 in the random access procedure or MSGA in the random access procedure;
first indication information in a first message after the random access procedure is completed; or
second indication information or third indication information in a capability-related message.

Reference may be made to the embodiments of the first aspect for implementations of the first resource and the first information, and repeated parts shall not be described herein any further.

In some embodiments, the first device is a repeater, and may also be one or some components or assemblies configured in the repeater.

In some embodiments, the first device selects/uses a repeater-specific random access resource and/or random access preamble.

In some embodiments, that the first device selects/uses a repeater-specific random access resource and/or a random access preamble includes:
when a random access procedure is initialized, using the repeater-specific random access resource and/or the random access preamble by the first device; or,
selecting a downlink reference signal by the first device, the downlink reference signal being configured with a repeater-specific random access resource and/or a random access preamble; and
according to the selected downlink reference signal, determining the repeater-specific random access resource and/or the random access preamble by the first device from multiple random access resources and/or random access preambles associated with the downlink reference signal.

In some embodiments, the method may further include (optional):
502: the first device further receives configuration information transmitted by the network device.

Furthermore, reference may be made to the embodiments of the first aspect for implementation of the configuration information, and repeated parts shall not be described herein any further.

It should be noted that FIG. 5 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 5.

It can be seem from the above embodiments that the first network device is enabled according to the first information and/or the first resource to determine that the first device is a repeater or determine that the first device connects to a network as a repeater, and furthermore, the first network device may be enabled to identify and distinguish whether the first device is a repeater or a normal terminal equipment, so that the network device separately processes connecting, message transmission, identification and authentication of the repeater, thereby achieving flexible deployment of repeaters and lowering network deployment costs.

### Embodiments of a Third Aspect

The embodiments of this disclosure provide a device identification apparatus. The apparatus may be, for example, a base station, or may also be one or more components or assemblies configured in the base station, with contents identical to those in the embodiments of the first aspect being not going to be described herein any further.

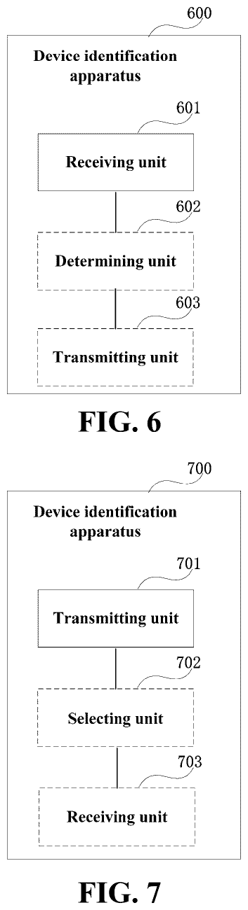

FIG. 6 is a schematic diagram of a device identification apparatus of the embodiment of this disclosure. As shown in FIG. 6, a device identification apparatus 600 includes:
a receiving unit 601 configured to receive first information transmitted by a first device, wherein,
the first information is used to indicate that the first device is a repeater or is used to determine that the first device connects to a network as a repeater; or, the first information is repeater-specific first information; or, the first information is transmitted on a first resource, the first resource being a repeater-specific first resource.

In some embodiments, the apparatus may further include (optional):
a determining unit 602 configured to determine that the first device is a repeater or that the first device connects to a network as a repeater according to the first information and/or the first resource.

In some embodiments, reference may be made to 400-401 in the embodiments of the first aspect for the receiving unit 601 and the determining unit 602, and reference may be made to the embodiments of the first aspect for the first information and/or the first resource, which shall not be described herein any further.

In some embodiments, the device identification apparatus 600 may further include (optional): a transmitting unit 603 configured to transmit configuration information to the first device.

Furthermore, reference may be made to the embodiments of the first aspect for implementation of the configuration information, which shall not be described herein any further.

The above implementations only illustrate the embodiments of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the device identification apparatus 600 may further include other components or modules, and reference may be made to related techniques for particulars of these components or modules.

Furthermore, for the sake of simplicity, connection relationships between the components or modules or signal profiles thereof are only illustrated in FIG. 6. However, it should be understood by those skilled in the art that such related techniques as bus connection, etc., may be adopted. And the above components or modules may be implemented by hardware, such as a processor, a memory, a transmitter, and a receiver, etc., which are not limited in the embodiments of this disclosure.

It can be seen from the above embodiments that the first network device is enabled according to the first information and/or the first resource to determine that the first device is a repeater or determine that the first device connects to a network as a smart repeater, and furthermore, the first network device may be enabled to identify and distinguish whether the first device is a repeater or a normal terminal equipment, so that the network device separately processes connecting, message transmission, identification and authentication of the repeater, thereby achieving flexible deployment of repeaters and lowering network deployment costs.

### Embodiments of a Fourth Aspect

The embodiments of this disclosure provide a device identification apparatus. The apparatus may be, for example, a first device.

FIG. 7 is a schematic diagram of a device identification apparatus of the embodiment of this disclosure. As shown in FIG. 7, a device identification apparatus 700 includes:
a transmitting unit 701 configured to transmit first information to a first network device, the first information being used to indicate that the first device is a repeater or being used to determine that the first device connects to a network as a repeater, or, the first information being repeater-specific first information, or, the first information being transmitted on a first resource, the first resource being a repeater-specific first resource.

In some embodiments, the first resource includes: a random access resource carrying a random access preamble of MSG1/MSGA in the random access procedure, or a physical uplink shared resource (PUSCH) carrying MSGA in the random access procedure.

In some embodiments, the first information includes at least one of the following information: a random access preamble of MSG1/MSGA in a random access procedure;
relevant information on a payload carried by MSG3 in the random access procedure or MSGA in the random access procedure;
first indication information in a first message after the random access procedure is completed; or
second indication information or third indication information in a capability-related message.

Reference may be made to the embodiments of the first aspect for implementations of the first resource and the first information, which shall not be described herein any further.

In some embodiments, the first device is a repeater, and may also be one or some components or assemblies configured in the repeater.

In some embodiments, the device identification apparatus 700 may further include (optional): a selecting unit 702 configured to select/use a repeater-specific random access resource and/or a random access preamble.

Reference may be made to the embodiments of the first aspect for implementations of the repeater-specific random access resource and/or the random access preamble, which shall not be described herein any further.

In some embodiments, the device identification apparatus 700 may further include (optional): a receiving unit 703 configured to receive configuration information transmitted by the network device.

Reference may be made to the embodiments of the first aspect for implementation of the configuration information, which shall not be described herein any further.

It should be noted that FIG. 7 only schematically illustrates the embodiments of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 7.

It can be seen from the above embodiments that the first network device is enabled according to the first information and/or the first resource to determine that the first device is a smart repeater or determine that the first device connects to a network as a smart repeater, and furthermore, the first network device may be enabled to identify and distinguish whether the first device is a repeater or a normal terminal equipment, so that the network device separately processes connecting, message transmission, identification and authentication of the repeater, thereby achieving flexible deployment of repeaters and lowering network deployment costs.

### Embodiments of a Fifth Aspect

The embodiments of this disclosure provide a communication system, and reference may be made to FIG. 1, with contents identical to those in the embodiments of the first to the fourth aspects being not going to be described herein any further.

In some embodiments, the communication system 100 at least includes a network device 800, a first device 900 and a terminal equipment 1000.

In some embodiments, the network device 800 receives first information transmitted by the first device 900, wherein the first information is used to indicate that the first device is a repeater or is used to determine that the first device connects to a network as a repeater; or, the first information is repeater-specific first information; or, the first information is transmitted on a first resource, the first resource being a repeater-specific first resource.

The embodiments of this disclosure further provide a network device, which may be, for example, a base station. However, this disclosure is not limited thereto, and it may also be another network device.

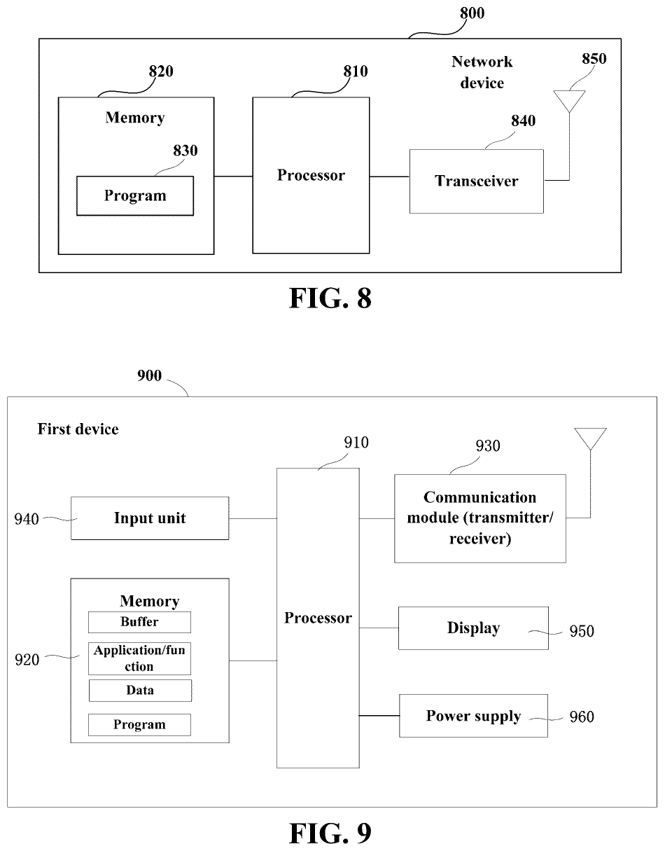

FIG. 8 is a schematic diagram of a structure of the network device 800 of the embodiment of this disclosure. As shown in FIG. 8, the network device 800 may include a processor 810 (such as a central processing unit (CPU)) and a memory 820, the memory 820 being coupled to the processor 810. The memory 820 may store various data, and furthermore, it may store a program 830 for information processing, and execute the program 830 under control of the processor 810.

For example, the processor 810 may be configured to execute a program to carry out the device identification method as described in the embodiments of the first aspect.

Furthermore, as shown in FIG. 8, the network device 800 may include a transceiver 840, and an antenna 850, etc. Functions of the above components are similar to those in the related art, and shall not be described herein any further. It should be noted that the network device 800 does not necessarily include all the parts shown in FIG. 8, and furthermore, the network device 800 may include parts not shown in FIG. 8, and the related art may be referred to.

The embodiments of this disclosure further provide a first device. The first device is, optionally, a repeater; however, this disclosure is not limited thereto, and it may also be other devices, such as a terminal equipment having functions of a repeater.

FIG. 9 is a schematic diagram of the first device 900 of the embodiment of this disclosure. As shown in FIG. 9, the first device 900 may include a processor 910 and a memory 920, the memory 920 storing data and a program and being coupled to the processor 910. It should be noted that this figure is illustrative only, and other types of structures may also be used, so as to supplement or replace this structure and achieve a telecommunications function or other functions.

For example, the processor 910 may be configured to execute a program to carry out the device identification method as described in the embodiments of the second aspect.

As shown in FIG. 9, the first device 900 may further include a communication module 930, an input unit 940, a display 950, and a power supply 960, wherein functions of the above components are similar to those in the related art, which shall not be described herein any further. It should be noted that the first device 900 does not necessarily include all the parts shown in FIG. 9, and the above components are not necessary. Furthermore, the first device 900 may include parts not shown in FIG. 9, and the related art may be referred to.

The embodiments of this disclosure further provide a terminal equipment. The terminal equipment is, optionally, a normal terminal equipment different from a repeater; however, this disclosure is not limited thereto, and it may also be other equipments.

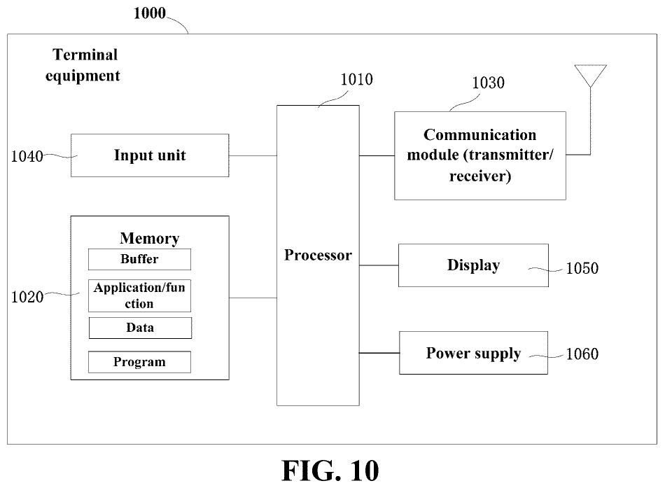

FIG. 10 is a schematic diagram of the terminal equipment of the embodiments of this disclosure. As shown in FIG. 10, the terminal equipment 1000 may include a processor 1010 and a memory 1020, the memory 1020 storing data and a program and being coupled to the processor 1010. It should be noted that this figure is illustrative only, and other types of structures may also be used, so as to supplement or replace this structure and achieve a telecommunications function or other functions.

As shown in FIG. 10, the terminal equipment 1000 may further include a communication module 1030, an input unit 1040, a display 1050, and a power supply 1060, wherein functions of the above components are similar to those in the related art, which shall not be described herein any further. It should be noted that the terminal equipment 1000 does not necessarily include all the parts shown in FIG. 10, and the above components are not necessary. Furthermore, the terminal equipment 1000 may include parts not shown in FIG. 10, and the related art may be referred to.

An embodiment of this disclosure provides a computer readable program, which, when executed in a network device, causes the network device to carry out the device identification method as described in the embodiments of the first aspect.

An embodiment of this disclosure provides a computer storage medium, including a computer readable program, which causes a network device to carry out the device identification method as described in the embodiments of the first aspect.

An embodiment of this disclosure provides a computer readable program, which, when executed in a first device, causes the first device to carry out the device identification method as described in the embodiments of the second aspect.

An embodiment of this disclosure provides a computer storage medium, including a computer readable program, which causes a first device to carry out the device identification method as described in the embodiments of the second aspect.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of the present disclosure. Various variants and modifications may be made by those skilled in the art according to the spirits and principle of the present disclosure, and such variants and modifications fall within the scope of the present disclosure.

As to implementations containing the above embodiments, following supplements are further disclosed.
1. A device identification method, applicable to a first network device, characterized in that the method including:
receiving first information transmitted by a first device, wherein,
the first information is used to indicate that the first device is a repeater or is used to determine that the first device connects to a network as a repeater; or, the first information is repeater-specific first information; or, the first information is transmitted on a first resource, the first resource being a repeater-specific first resource.
2. The method according to supplement 1, wherein the method further including:
determining that the first device is a repeater or that the first device connects to a network as a repeater according to the first information and/or the first resource.
3. The method according to supplement 1 or 2, wherein the first resource includes a random access resource carrying a random access preamble of MSG1/MSGA in a random access procedure, or a physical uplink shared resource (PUSCH) carrying MSGA in a random access procedure.
4. The method according to any one of supplements 1-3, wherein the first information includes at least one of the following information:
a random access preamble of MSG1/MSGA in a random access procedure;
relevant information on a payload carried by MSG3 in the random access procedure or MSGA in the random access procedure;
first indication information in a first message after the random access procedure is completed; or
second indication information or third indication information in a capability-related message.
5. The method according to supplement 3 or 4, wherein the method further including:
transmitting configuration information to the first device, the configuration information including at least one of the following information:
repeater-specific PRACH configuration information, or repeater-specific random access preamble configuration information.
6. The method according to supplement 5, wherein,
the repeater-specific PRACH configuration information includes at least one of the following information:
the number of PRACH transmission occasions frequency-division multiplexed in one time instance;
an offset of a lowest PRACH transmission occasion in a frequency domain relative to PRBO;
an index of PRACH configuration;
a subcarrier spacing of a PRACH;
the number of SSBs per RACH occasion;
a scaling factor of a PRACH configuration period; or
a frame offset of a PARCH transmission occasion.
7. The method according to supplement 5, wherein,
the repeater-specific random access preamble configuration information includes at least one of the following information:
a PRACH root sequence index;
the number of preambles used for contention-based random access of the repeater;
the number of contention-based preambles per SSB in group A;
the number of contention-based preambles per SSB;
a total number of preambles used for contention-based 4-step random access or 2-step random access in an RACH resource; or
existing random access preamble subset indication information.
8. The method according to supplement 5 or 6, wherein the first resource is determined according to the repeater-specific PRACH configuration information.
9. The method according to supplement 5 or 7, wherein a random access preamble taken as the first information is determined according to the repeater-specific random access preamble configuration information.
10. The method according to supplement 4 or 5, wherein, the relevant information includes cause value information or a user identifier (UE ID).
11. The method according to supplement 10, wherein the cause value information is a predetermined value indicating that the first device is a repeater or that the device connects a network as a repeater.
12. The method according to supplement 10, wherein,
the cause value information is an establishment cause value or a resume cause value, wherein,
the establishment cause value is indicated by a higher layer to an RRC layer of the first device or is determined by the RRC layer itself of the first device;
and the resume cause value is indicated by the higher layer to an RRC layer of the first device or is determined by the AS layer itself of the first device.
13. The method according to supplement 10, wherein,
the user identifier (UE ID) is obtained according to a repeater-specific device ID configured by a second network device for the repeater, the repeater-specific device ID being a predetermined identifier indicating that the first device is a repeater or that the first device connects to a network as a repeater.
14. The method according to supplement 4, wherein,
a first message (Msg5) after the random access procedure is completed is an RRC establishment complete message or an RRC resume complete message, and the first indication information is used to indicate that the first device is a repeater or is used to indicate that the first device connects to a network as a repeater.
15. The method according to supplement 4, wherein,
the capability-related message includes:
a UE capability information (UECapabilityInformation) message or a UE assistance information (UEAssistanceInformation) message.
16. The method according to supplement 14, wherein,
the second indication information is used to indicate that the first device is a repeater or is used to indicate that the first device connects to a network as a repeater or is used to indicate that the first device has a capability of a repeater;
and the third indication information is information indicating a first capability in the UE capability information (UECapabilityInformation) message or the UE assistance information (UEAssistanceInformation) message, the first capability being a repeater-specific capability.
17. A device identification method, applicable to a first device, characterized in that the method including:
transmitting first information by the first device to a first network device, the first information being used to indicate that the first device is a repeater or being used to determine that the first device connects to a network as a repeater, or, the first information being repeater-specific first information, or, the first information being transmitted on a first resource, the first resource being a repeater-specific first resource.
18. The method according to supplement 17, wherein,
the first resource includes: a random access resource carrying a random access preamble of MSG1/MSGA in a random access procedure, or a physical uplink shared resource (PUSCH) carrying MSGA in a random access procedure.
19. The method according to supplement 17, wherein the first information includes at least one of the following information:
a random access preamble of MSG1/MSGA in a random access procedure;
relevant information on a payload carried by MSG3 in the random access procedure or MSGA in the random access procedure;
first indication information in a first message after the random access procedure is completed; or
second indication information or third indication information in a capability-related message.
20. The method according to supplement 17, wherein the method further including:
selecting/using a repeater-specific random access resource and/or a random access preamble by the first device.
21. The method according to supplement 18, wherein the selecting/using a repeater-specific random access resource and/or a random access preamble by the first device includes:
when a random access procedure is initialized, using the repeater-specific random access resource and/or the random access preamble by the first device; or,
selecting a downlink reference signal by the first device, the downlink reference signal being configured with a repeater-specific random access resource and/or a random access preamble; and
according to the selected downlink reference signal, determining the repeater-specific random access resource and/or the random access preamble from multiple random access resources and/or random access preambles associated with the downlink reference signal.
22. The method according to supplement 18 or 19, wherein the method further including:
receiving configuration information transmitted by the network device, the configuration information including at least one of the following information:
repeater-specific PRACH configuration information, or
repeater-specific random access preamble configuration information.
23. The method according to supplement 22, wherein,
the repeater-specific PRACH configuration information includes at least one of the following information:
the number of PRACH transmission occasions frequency-division multiplexed in one time instance;
an offset of a lowest PRACH transmission occasion in a frequency domain relative to PRBO;
an index of PRACH configuration;
a subcarrier spacing of a PRACH;
the number of SSBs per RACH occasion;
a scaling factor of a PRACH configuration period; or
a frame offset of a PARCH transmission occasion.
24. The method according to supplement 22, wherein,
the repeater-specific random access preamble configuration information includes at least one of the following information:
a PRACH root sequence index;
the number of preambles used for contention-based random access of the repeater;
the number of contention-based preambles per SSB in group A;
the number of contention-based preambles per SSB;
a total number of preambles used for contention-based 4-step random access or 2-step random access in an RACH resource; or
existing random access preamble subset indication information.
25. The method according to supplement 22 or 23, wherein the first resource is determined according to the repeater-specific PRACH configuration information.
26. The method according to supplement 22 or 24, wherein a random access preamble taken as the first information is determined according to the repeater-specific random access preamble configuration information.
27. The method according to supplement 18 or 19, wherein,
the relevant information includes cause value information or a user identifier (UE ID).
28. The method according to supplement 27, wherein the cause value information is a predetermined value indicating that the first device is a repeater or that the device connects a network as a repeater.
29. The method according to supplement 27, wherein,
the cause value information is an establishment cause value or a resume cause value, wherein,
the establishment cause value is indicated by a higher layer to an RRC layer of the first device or is determined by the RRC layer itself of the first device;
and the resume cause value is indicated by the higher layer to an AS layer of the first device or is determined by the AS layer itself of the first device.
30. The method according to supplement 27, wherein,
the user identifier (UE ID) is obtained according to a repeater-specific device ID configured by a second network device for the repeater, the repeater-specific device ID being a predetermined identifier indicating that the first device is a repeater or that the first device connects to a network as a repeater.
31. The method according to supplement 19, wherein,
a first message (Msg5) after the random access procedure is completed is an RRC establishment complete message or an RRC resume complete message, and the first indication information is used to indicate that the first device is a repeater or is used to indicate that the first device connects to a network as a repeater.
32. The method according to supplement 19, wherein,
the capability-related message includes:
a UE capability information (UECapabilityInformation) message or a UE assistance information (UEAssistanceInformation) message.
33. The method according to supplement 19, wherein,
the second indication information is used to indicate that the first device is a repeater or is used to indicate that the first device connects to a network as a repeater or is used to indicate that the first device has a capability of a repeater;
and the third indication information is information indicating a first capability in the UE capability information (UECapabilityInformation) message or the UE assistance information (UEAssistanceInformation) message, the first capability being a repeater-specific capability.
34. A network device, including a memory and a processor, the memory storing a computer program, wherein the processor is configured to execute the computer program to carry out the method described in any one of supplements 1-16.
35. A first device, including a memory and a processor, the memory storing a computer program, wherein the processor is configured to execute the computer program to carry out the method described in any one of supplements 17-33.
36. A communication system, including:
the first device as described in supplement 35, and/or the network device as described in supplement 34.
37. A device identification apparatus, applicable to a first network device, characterized in that the apparatus includes:
a receiving unit configured to receive first information transmitted by a first device, wherein,
the first information is used to indicate that the first device is a repeater or is used to determine that the first device connects to a network as a repeater; or, the first information is repeater-specific first information; or, the first information is transmitted on a first resource, the first resource being a repeater-specific first resource.
38. The apparatus according to supplement 37, wherein the apparatus further includes:
a determining unit configured to determine that the first device is a repeater or that the first device connects to a network as a repeater according to the first information and/or the first resource.
39. The apparatus according to supplement 37 or 38, wherein,
the first resource includes: a random access resource carrying a random access preamble of MSG1/MSGA in a random access procedure, or a physical uplink shared resource (PUSCH) carrying MSGA in a random access procedure.
40. The apparatus according to any one of supplements 37-39, wherein,
the first information includes at least one of the following information:
a random access preamble of MSG1/MSGA in a random access procedure;
relevant information on a payload carried by MSG3 in the random access procedure or MSGA in the random access procedure;
first indication information in a first message after the random access procedure is completed; or
second indication information or third indication information in a capability-related message.
41. The apparatus according to supplement 39 or 40, wherein the apparatus further includes:
a transmitting unit configured to transmit configuration information to the first device, the configuration information including at least one of the following information:
repeater-specific PRACH configuration information, or
repeater-specific random access preamble configuration information.
42. The apparatus according to supplement 41, wherein,
the repeater-specific PRACH configuration information includes at least one of the following information:
the number of PRACH transmission occasions frequency-division multiplexed in one time instance;
an offset of a lowest PRACH transmission occasion in a frequency domain relative to PRBO;
an index of PRACH configuration;
a subcarrier spacing of a PRACH;
the number of SSBs per RACH occasion;
a scaling factor of a PRACH configuration period; or
a frame offset of a PARCH transmission occasion.
43. The apparatus according to supplement 41, wherein,
the repeater-specific random access preamble configuration information includes at least one of the following information:
a PRACH root sequence index;
the number of preambles used for contention-based random access of the repeater;
the number of contention-based preambles per SSB in group A;
the number of contention-based preambles per SSB;
a total number of preambles used for contention-based 4-step random access or 2-step random access in an RACH resource; or
existing random access preamble subset indication information.
44. The apparatus according to supplement 41 or 42, wherein the first resource is determined according to the repeater-specific PRACH configuration information.
45. The apparatus according to supplement 41 or 43, wherein a random access preamble taken as the first information is determined according to the repeater-specific random access preamble configuration information.
46. The apparatus according to supplement 40 or 41, wherein,
the relevant information includes cause value information or a user identifier (UE ID).
47. The apparatus according to supplement 46, wherein the cause value information is a predetermined value indicating that the first device is a repeater or that the device connects a network as a repeater.
48. The apparatus according to supplement 46, wherein,
the cause value information is an establishment cause value or a resume cause value, wherein,
the establishment cause value is indicated by a higher layer to an RRC layer of the first device or is determined by the RRC layer itself of the first device;
and the resume cause value is indicated by the higher layer to an AS layer of the first device or is determined by the AS layer itself of the first device.
49. The apparatus according to supplement 46, wherein,
the user identifier (UE ID) is obtained according to a repeater-specific device ID configured by a second network device for the repeater, the repeater-specific device ID being a predetermined identifier indicating that the first device is a repeater or that the first device connects to a network as a repeater.
50. The apparatus according to supplement 40, wherein,
a first message (Msg5) after the random access procedure is completed is an RRC establishment complete message or an RRC resume complete message, and the first indication information is used to indicate that the first device is a repeater or is used to indicate that the first device connects to a network as a repeater.
51. The apparatus according to supplement 40, wherein,
the capability-related message includes:
a UE capability information (UECapabilityInformation) message or a UE assistance information (UEAssistanceInformation) message.
52. The apparatus according to supplement 40, wherein,
the second indication information is used to indicate that the first device is a repeater or is used to indicate that the first device connects to a network as a repeater or is used to indicate that the first device has a capability of a repeater;
and the third indication information is information indicating a first capability in the UE capability information (UECapabilityInformation) message or the UE assistance information (UEAssistanceInformation) message, the first capability being a repeater-specific capability.
53. A device identification apparatus, applicable to a first device, characterized in that the apparatus includes:
a transmitting unit configured to transmit first information to a first network device, the first information being used to indicate that the first device is a repeater or being used to determine that the first device connects to a network as a repeater, or, the first information being repeater-specific first information, or, the first information being transmitted on a first resource, the first resource being a repeater-specific first resource.
54. The apparatus according to supplement 53, wherein,
the first resource includes: a random access resource carrying a random access preamble of MSG1/MSGA in a random access procedure, or a physical uplink shared resource (PUSCH) carrying MSGA in a random access procedure.
55. The apparatus according to supplement 53, wherein,
the first information includes at least one of the following information:
a random access preamble of MSG1/MSGA in a random access procedure;
relevant information on a payload carried by MSG3 in the random access procedure or MSGA in the random access procedure;
first indication information in a first message after the random access procedure is completed; or
second indication information or third indication information in a capability-related message.
56. The apparatus according to supplement 54, wherein the apparatus further includes:
a selecting unit configured to select/use a repeater-specific random access resource and/or a random access preamble.
57. The apparatus according to supplement 55, wherein,
when a random access procedure is initialized, the selecting unit uses the repeater-specific random access resource and/or the random access preamble; or,
the selecting unit selects a downlink reference signal, the downlink reference signal being configured with a repeater-specific random access resource and/or a random access preamble; and
according to the selected downlink reference signal, determines the repeater-specific random access resource and/or the random access preamble from multiple random access resources and/or random access preambles associated with the downlink reference signal.
58. The apparatus according to supplement 54 or 55, wherein the apparatus further includes:
a receiving unit configured to receive configuration information transmitted by the network device, the configuration information including at least one of the following information:
repeater-specific PRACH configuration information, or
repeater-specific random access preamble configuration information.
59. The apparatus according to supplement 58, wherein,
the repeater-specific PRACH configuration information includes at least one of the following information:
the number of PRACH transmission occasions frequency-division multiplexed in one time instance;
an offset of a lowest PRACH transmission occasion in a frequency domain relative to PRBO;
an index of PRACH configuration;
a subcarrier spacing of a PRACH;
the number of SSBs per RACH occasion;
a scaling factor of a PRACH configuration period; or
a frame offset of a PARCH transmission occasion.
60. The apparatus according to supplement 58, wherein,
the repeater-specific random access preamble configuration information includes at least one of the following information:
a PRACH root sequence index;
the number of preambles used for contention-based random access of the repeater;
the number of contention-based preambles per SSB in group A;
the number of contention-based preambles per SSB;
a total number of preambles used for contention-based 4-step random access or 2-step random access in an RACH resource; or
existing random access preamble subset indication information.
61. The apparatus according to supplement 58 or 59, wherein the first resource is determined according to the repeater-specific PRACH configuration information.
62. The apparatus according to supplement 58 or 60, wherein a random access preamble taken as the first information is determined according to the repeater-specific random access preamble configuration information.
63. The apparatus according to supplement 55 or 56, wherein,
the relevant information includes cause value information or a user identifier (UE ID).
64. The apparatus according to supplement 63, wherein the cause value information is a predetermined value indicating that the first device is a repeater or that the device connects a network as a repeater.
65. The apparatus according to supplement 63, wherein,
the cause value information is an establishment cause value or a resume cause value, wherein,
the establishment cause value is indicated by a higher layer to an RRC layer of the first device or is determined by the RRC layer itself of the first device;
and the resume cause value is indicated by the higher layer to an AS layer of the first device or is determined by the AS layer itself of the first device.
66. The apparatus according to supplement 63, wherein,
the user identifier (UE ID) is obtained according to a repeater-specific device ID configured by a second network device for the repeater, the repeater-specific device ID being a predetermined identifier indicating that the first device is a repeater or that the first device connects to a network as a repeater.
67. The apparatus according to supplement 55, wherein,
a first message (Msg5) after the random access procedure is completed is an RRC establishment complete message or an RRC resume complete message, and the first indication information is used to indicate that the first device is a repeater or is used to indicate that the first device connects to a network as a repeater.
68. The apparatus according to supplement 55, wherein,
the capability-related message includes:
a UE capability information (UECapabilityInformation) message or a UE assistance information (UEAssistanceInformation) message.
69. The apparatus according to supplement 55, wherein,
the second indication information is used to indicate that the first device is a repeater or is used to indicate that the first device connects to a network as a repeater or is used to indicate that the first device has a capability of a repeater;
and the third indication information is information indicating a first capability in the UE capability information (UECapabilityInformation) message or the UE assistance information (UEAssistanceInformation) message, the first capability being a repeater-specific capability.

1. A device identification apparatus, applicable to a first network device, the device identification apparatus comprising:
a receiver configured to receive first information transmitted by a first device, wherein,
the first information is used to indicate that the first device is a Network-Controlled repeater or is used to determine that the first device connects to a network as a Network-Controlled repeater; or, the first information is repeater-specific first information.

2. The device identification apparatus according to claim 1, further comprising:
processor circuitry configured to determine that the first device is a Network-Controlled repeater or that the first device connects to a network as a Network-Controlled repeater according to the first information.

3. The device identification apparatus according to claim 1, wherein,
the first information includes first indication information in a first message after random access procedure is completed.

4. The device identification apparatus according to claim 3, wherein,
the first message after the random access procedure is completed is an RRC (radio resource control) setup complete message.

5. The device identification apparatus according to claim 4, wherein,
the first indication information in the first message after random access procedure is completed is used to indicate that the first device connects to a network as a Network-Controlled repeater.

6. The device identification apparatus according to claim 1, further comprising:
a transmitter configured to transmit configuration information to the first device, the configuration information comprising at least one of the following information:
repeater-specific PRACH (physical random access channel) configuration information, or
repeater-specific random access preamble configuration information.

7. The device identification apparatus according to claim 6, wherein,
the repeater-specific PRACH configuration information comprises at least one of the following information:
the number of PRACH transmission occasions frequency-division multiplexed in one time instance;
an offset of a lowest PRACH transmission occasion in a frequency domain relative to PRBO (physical resource block 0);
an index of PRACH configuration;
a subcarrier spacing of a PRACH;
the number of SSBs (synchronization signal blocks) per RACH (random access channel) occasion;
a scaling factor of a PRACH configuration period; or
a frame offset of a PARCH transmission occasion.

8. The device identification apparatus according to claim 6, wherein,
the repeater-specific random access preamble configuration information includes at least one of the following information:
a PRACH root sequence index;
the number of preambles used for contention-based random access of the repeater;
the number of contention-based preambles per SSB in group A;
the number of contention-based preambles per SSB;
a total number of preambles used for contention-based 4-step random access or 2-step random access in an RACH resource; or
existing random access preamble subset indication information.

9. A device identification apparatus, applicable to a first device, the device identification apparatus comprising:
a transmitter configured to transmit first information to a first network device, the first information being used to indicate that the first device is a Network-Controlled repeater or is used to determine that the first device connects to a network as a Network-Controlled repeater, or, the first information being repeater-specific first information.

10. The device identification apparatus according to claim 9, wherein,
the first information includes first indication information in a first message after random access procedure is completed.

11. The device identification apparatus according to claim 10, wherein,
the first message after the random access procedure is completed is an RRC (radio resource control) setup complete message.

12. The device identification apparatus according to claim 11, wherein,
the first indication information in the first message after random access procedure is completed is used to indicate that the first device connects to a network as a Network-Controlled repeater.

13. The device identification apparatus according to claim 9, wherein the apparatus further comprises:
a receiver configured to receive configuration information from the first network device, the configuration information comprising at least one of the following information:
repeater-specific PRACH (physical random access channel) configuration information, or
repeater-specific random access preamble configuration information.

14. The device identification apparatus according to claim 13, wherein,
the repeater-specific PRACH configuration information comprises at least one of the following information:
the number of PRACH transmission occasions frequency-division multiplexed in one time instance;
an offset of a lowest PRACH transmission occasion in a frequency domain relative to PRBO (physical resource block 0);
an index of PRACH configuration;
a subcarrier spacing of a PRACH;
the number of SSBs (synchronization signal blocks) per RACH (random access channel) occasion;
a scaling factor of a PRACH configuration period; or
a frame offset of a PARCH transmission occasion.

15. The device identification apparatus according to claim 13, wherein,
the repeater-specific random access preamble configuration information comprises at least one of the following information:
a PRACH root sequence index;
the number of preambles used for contention-based random access of the repeater;
the number of contention-based preambles per SSB in group A;
the number of contention-based preambles per SSB;
a total number of preambles used for contention-based 4-step random access or 2-step random access in an RACH resource; or
existing random access preamble subset indication information.

16. The device identification apparatus according to claim 9, further comprising:
processor circuitry configured to select/use a repeater-specific random access resource and/or a random access preamble.

17. The device identification apparatus according to claim 16, wherein,
when a random access procedure is initialized, the processor circuitry is configured to use the repeater-specific random access resource and/or the random access preamble; or,
the processor circuitry is configured to select a downlink reference signal, the downlink reference signal being configured with a repeater-specific random access resource and/or a random access preamble;
and according to a selected downlink reference signal, the processor circuitry is configured to determine the repeater-specific random access resource and/or the random access preamble from multiple random access resources and/or random access preambles associated with the downlink reference signal.

18. A communication system comprising:
a first device configured to, transmit first information,
a first network device configured to receive the first information transmitted by the first device,
wherein, the first information is used to indicate that the first device is a Network-Controlled repeater or is used to determine that the first device connects to a network as a Network-Controlled repeater; or, the first information is repeater-specific first information.
